(19) United States
(12) Patent Application Publication
(10) Pub. No.: US 2011/0033225 A1
(43) Pub. Date: Feb. 10, 2011

(54) METHOD OF MANUFACTURING A LINK ROD FOR AERONAUTICAL CONSTRUCTION

(75) Inventor: Jean-Michel BUCHIN, Lons Le Saunier (FR)

Correspondence Address: DOWELL & DOWELL P.C., 103 Oronoco St., Suite 220, Alexandria, VA, 22314, US

(73) Assignee: SKF AEROSPACE FRANCE, Saint-Vallier-Sur-Rhone (FR)

(21) Appl. No.: 12/814,846

(22) Filed: Jun. 14, 2010

(30) Foreign Application Priority Data
Jun. 16, 2009 (FR) 09 54020

(51) Int. Cl. F16C 11/04; B32B 37/00

(52) U.S. Cl. 403/119; 156/60

(57) ABSTRACT

According to this method, plastic welding is used to secure one longitudinal end (11) of a tube (10) made of thermoplastic to a dedicated part (21), made of thermoplastic, of an end piece (20) designed to be joined in an articulated manner to a structural component. According to the invention, the tube is manufactured by extruding thermoplastic in order to obtain a hollow section piece one length of which constitutes the tube and which, at the longitudinal end of the tube, has at least one flat surface (12, 13) parallel to the longitudinal axis (X-X′) of the tube, and in order to perform the plastic welding, the said at least one flat surface of the longitudinal end of the tube is mated against a corresponding flat surface (22, 23) belonging to the dedicated part of the end piece, then the mated flat surfaces are welded together.

The present invention relates to a method of manufacturing a link rod for aeronautical construction, and to a corresponding link rod.

In order to transmit movement and/or force it is known practice, particularly in the aeronautical field, to use link rods the link rod body of which consists of a tube comprising a composite with a thermosetting matrix. This tube then combines lightness of weight with both tensile and compressive strength. The mounting tolerances on these link rods entail that they be adjustable in terms of length so as to make them easier to attach at their ends. For this purpose, the link rod may comprise an end fitting that allows the link rod to be fixed, connected or coupled to a structural component, it being possible for the longitudinal position of this end fitting to be adjusted with respect to the corresponding longitudinal end of the tube. To do that, the end fitting can be screwed into a metal insert fixedly secured to the end of the tube. By screwing the end fitting into/out of the insert, the effective length of the link rod can be adjusted.

It will be appreciated that the fixed connection between the metal insert and the composite tube needs to be as strong as possible. At the present time, there are various types of connection used for this purpose. The metal insert is bonded or riveted around the tube, the level of strength of the connection then being connected either with the shearing of the adhesive or with the hammering of the tube by the rivets. Another option is to co-inject the metal insert with the tube, the level of strength of the connection between these elements then being connected with the shearing of the material that makes up the matrix of the composite material of which the tube is formed. In all instances, the yield strength is often not high enough to ensure the mechanical durability of the link rod. Further, the metal of which the insert is made generally has a coefficient of expansion that is markedly higher than that of the composite of which the tube is made and this means that for the temperature variations that are commonplace in the aeronautical field, notably between −54° C. and +200° C., the expansion of the insert weakens the connection to the tube. This is particularly true of inserts made of aluminium or aluminium alloy, these being materials which are very widely used in the aeronautical field. Further, the securing of a link rod insert of the prior art entails an organic component of the bolt or rivet type, and this increases the cost and mass of the link rod. This securing further entails a bore or a tapping liable to weaken the longitudinal end of the tube and/or the end piece of the link rod.

U.S. Pat. No. 5,743,978 proposes manufacturing a link rod by using plastic welding to secure the transverse end edge face of a tube, obtained by injection moulding a plastic, to the transverse end edge face of an end piece, it too being obtained by injection moulding plastic. In order to carry out quality plastic welds, it is necessary to have precise control over the shapes of the moulded plastic elements, and this leads to significant technical and economic constraints.

It is an object of the present invention to provide a link rod which is simple and economical to manufacture while at the same time having a lightweight and robust structure.

To this end, a subject of the invention is a method of manufacturing a link rod for aeronautical construction, in which method plastic welding is used to secure one longitudinal end of a tube made of thermoplastic to a dedicated part, made of thermoplastic, of an end piece designed to be joined in an articulated manner to a structural component, wherein the tube is manufactured by extruding thermoplastic in order to obtain a hollow section piece one length of which constitutes the tube and which, at the longitudinal end of the tube, has at least one flat surface parallel to the longitudinal axis of the tube, and wherein, in order to perform the plastic welding, the said at least one flat surface of the longitudinal end of the tube is mated against a corresponding flat surface belonging to the dedicated part of the end piece, then the mated flat surfaces are welded together.

Another subject of the invention is a link rod for aeronautical construction, comprising:
a tube consisting of a length of hollow section piece which is obtained by extruding thermoplastic and which, at one longitudinal end, has at least one flat surface parallel to the longitudinal axis of the tube, and
an end piece which includes a dedicated part, made of thermoplastic, to which there is secured an articulation member designed to join the link rod to a structural component and which is secured to the tube by at least one plastic weld between the said at least one flat surface of the longitudinal end of the tube and a mating flat surface belonging to this dedicated part.

The invention thus proposes the manufacture of a link rod without the need for fixing components such as rivets or bolts, thus avoiding impairing the mechanical strength of the tube and/or the end piece. In addition, the tube and, advantageously, the end piece, are made from extruded hollow section pieces which are readily available at low cost, while at the same time guaranteeing effective plastic welding between the components of the link rod, thanks to the mating flat surfaces that these section pieces exhibit.

According to other advantageous but optional features of the invention, considered in isolation or in any technically permissible combination:
the shape of the cross section of the section piece one length of which constitutes the tube is selected from a group consisting of a rectangle, of a square, of a U, of a J, of an I, of an H and of a double H;
the end piece is manufactured from one or more thermoplastic section pieces;
the shape of the cross section of the section piece or pieces from which the end piece is manufactured is selected from a group consisting of a rectangle, of a square, of an H, of a double H, of a C, of a J, of an I and of a U;
the cross section of the end piece has a perimeter which decreases away from the longitudinal end of the tube;
in order to carry out the plastic welding, the end piece is partially housed in the longitudinal end of the tube;
the tube and/or the dedicated part of the end piece are made of a composite material involving a fibre-filled thermoplastic matrix;
the thermoplastic is selected from the group consisting of polyether ether ketone (PEEK), polyether ketone ketone (PEKK), poly(phenylene sulphide) (PPS), polyether imide (PEI);
the articulation member is made of a composite with a thermoplastic matrix or consists of an end fitting made of metal.

The present invention will be clearly understood and its advantages will become apparent also from reading the description which will follow, which is given solely by way of nonlimiting example and made with reference to the attached drawings, in which:

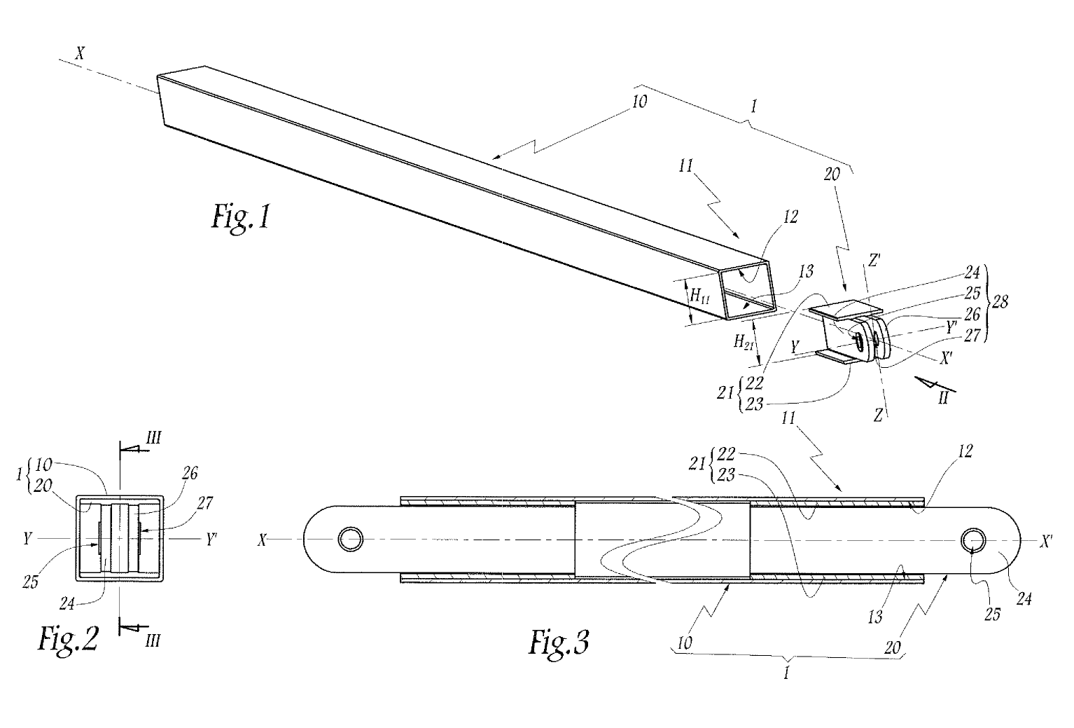

FIG. 1 is an exploded perspective view of a link rod according to a first embodiment of the invention in the unassembled state, before a method according to the invention is implemented;

FIG. 2 is a side-on view, in the direction of arrow II in FIG. 1, of the link rod of FIG. 1 in the assembled state, after a method according to the invention is implemented;

FIG. 3 is an interrupted section on of FIG. 2;

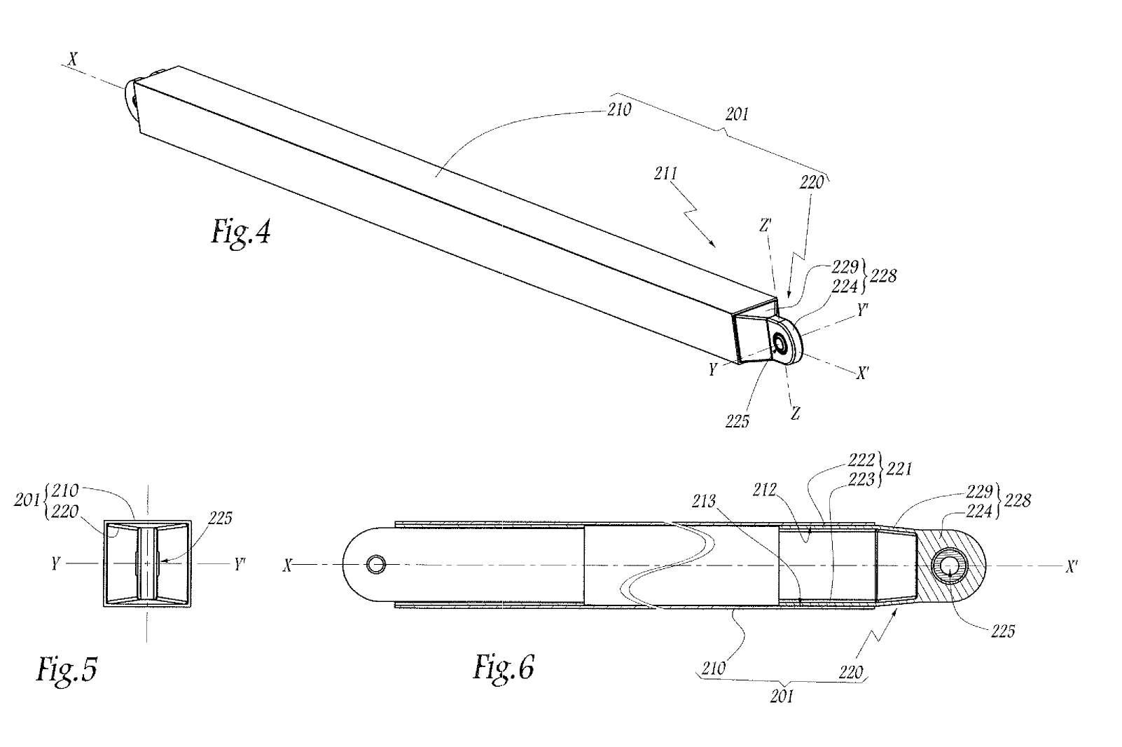

FIG. 4 is a view similar to FIG. 1 but of a link rod according to a second embodiment of the invention;

FIG. 5 is a view similar to FIG. 2, of the link rod of FIG. 4;

FIG. 6 is a view similar to FIG. 3, of the link rod of FIG. 4;

FIG. 7 is a view similar to FIG. 1 but of a link rod according to a third embodiment of the invention;

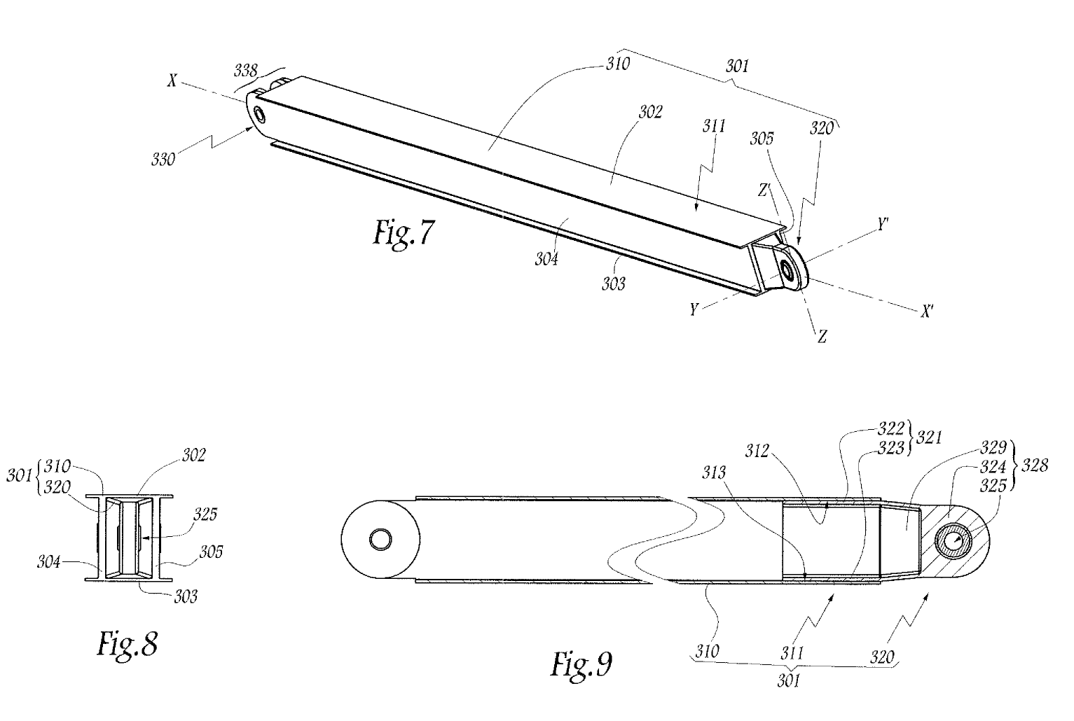

FIG. 8 is a view similar to FIG. 2, of the link rod of FIG. 7;

FIG. 9 is a view similar to FIG. 3, of the link rod of FIG. 7;

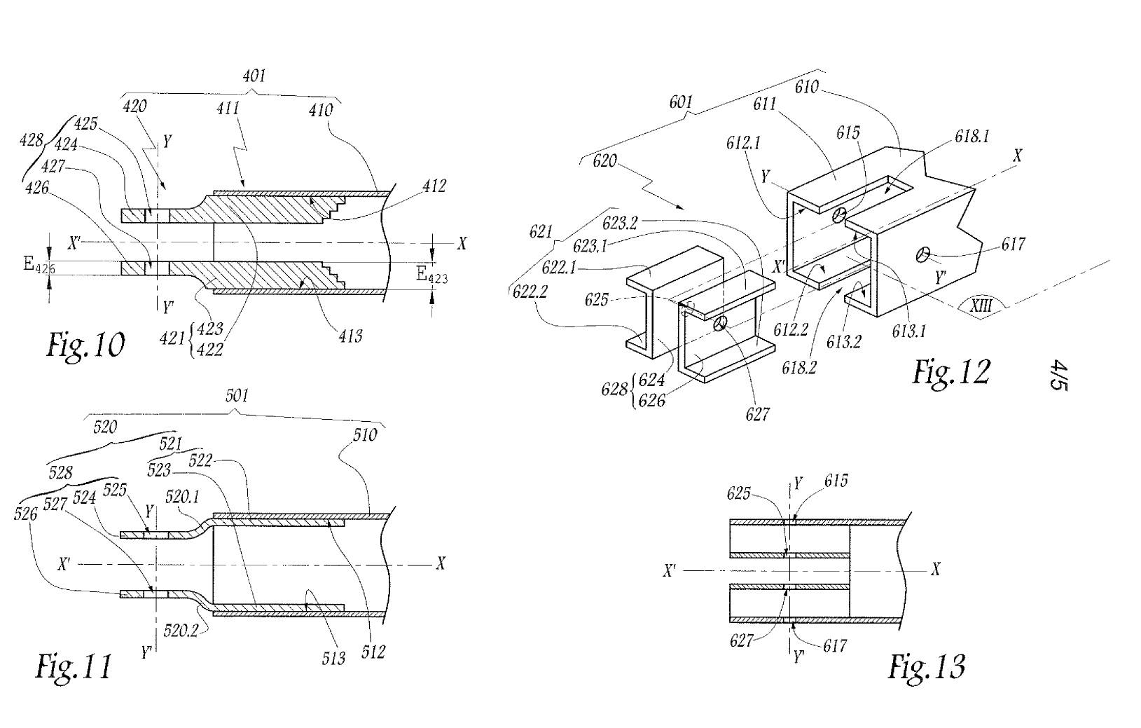

FIG. 10 is a section through part of a link rod according to a fourth embodiment of the invention;

FIG. 11 is a section through part of a link rod according to a fifth embodiment of the invention;

FIG. 12 is an exploded perspective view of part of a link rod according to a sixth embodiment of the invention, in the unassembled state, before a method according to the invention has been implemented;

FIG. 13 is a view in section on XIII of FIG. 12, of the link rod of FIG. 12 in the assembled state, after a method according to the invention has been implemented;

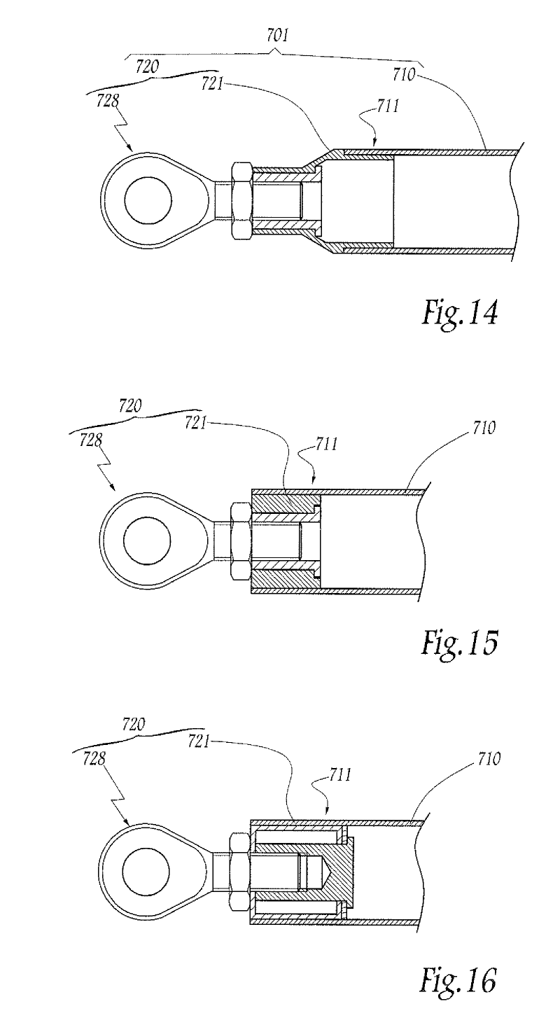

FIG. 14 is a section through part of a link rod according to a seventh embodiment of the invention;

FIG. 15 is a view similar to FIG. 14 of an alternative to the link rod of FIG. 14; and

FIG. 16 is a view similar to FIG. 14 of another alternative to the link rod of FIG. 14.

FIG. 1 shows a link rod 1 extending, on the whole, about a longitudinal axis X-X′. The link rod 1 is designed to transmit movement and/or force between, for example, two structural components which have not been depicted. The link rod 1 comprises a link rod body in the form of a tube 10 and an end piece 20, which are designed to be assembled with one another using the method of manufacture according to the invention and as described hereinafter.

In this application, the adjective “longitudinal” refers to a physical or geometric entity, such as a component, a surface or a direction, the position or orientation of which is directly dependent on the axis X-X′.

The tube 10 has a square-base prismatic overall shape. The tube 10 is in effect formed of a length of section piece a cross section of which is square. The tube 10 is hollow over all or part of its length, considered along the axis X-X′. In particular, the tube 10 has one longitudinal end 11 which is hollow and open. The tube 10 forms an elongate component designed to withstand the force transmitted by the link rod 1.

In this application, the adjective “transverse” refers to a physical or geometric entity, such as a component, a surface or a direction, which is oriented or extends along an axis Y-Y′ in FIG. 1 that is perpendicular to the longitudinal axis X-X′.

The end piece 20 comprises an articulation member 28 and a dedicated part 21 for securing the end piece 20 to the tube 10. In this particular instance, the articulation member 28 is secured to the dedicated part 21.

The dedicated part 21 here comprises two plates 22 and 23 which are mutually parallel and of which the length along the axis X-X′ is substantially equal to the width along the axis Y-Y′. Two lugs 24 and 26 are positioned between the plates 22 and 23. The lugs 24 and 26 each have the shape of a plate extending along the axis X-X′.

The lugs 24 and 26 are positioned at right angles to the plates 22 and 23, to which they are secured. The edges of the lugs 24 and 26 rest against the plates 22 and 23. In this particular instance, the lugs 24 and 26 are of one piece with the plates 22 and 23, because the end piece 20 is made from a section piece with a double-H cross section. Alternatively, the lugs 24 and 26 can be secured to the plates 22 and 23 for example by bonding, plastic welding, or any other equivalent means.

The lugs 24 and 26 act as articulation members to articulate the link rod 1. To this end, on the opposite side to the tube 10, the lugs 24 and 26 each have a portion that projects out beyond the plates 22 and 23. Each projecting portion of the lugs 24 and 26 has a respective hole 25 or 27 which is circular and opens onto each face of the respective lug 24 or 26. The holes 25 and 27 act as rotary bearings for a pin or for an articulation, not depicted, belonging to a structural component, not depicted, that is to say allow this pin or this articulation to pivot.

As FIGS. 2 and 3 show, the end piece 20 is secured to the tube 10. In order to assemble and secure the end piece 20 and the tube 10, the end piece 20 is fitted into the longitudinal end 11. More specifically, the dedicated part 21 is mated with the longitudinal end 11 in such a way as to cause the external flat surfaces of the plates 22 and 23 to collaborate with flat surfaces 12 and 13 belonging to the longitudinal end 11. In this particular instance, the external flat surfaces of the plates 22 and 23 have transverse dimensions that complement those of the flat surfaces 12 and 13. Collaboration between the flat surfaces 12 and 13 and the external flat surfaces of the plates 22 and 23 is achieved by mutual contact over extensive surface areas.

In order to allow the flat surfaces 12 and 13 to collaborate with the external flat surfaces of the plates 22 and 23, the latter are separated by a height H₂₁ equal, give or take the assembly clearance, to a height H₁₁ separating the flat surfaces 12 and 13. The heights H₂₁ and H₁₁ are measured along an axis Z-Z′ which is perpendicular to the axes X-X′ and Y-Y′.

The end piece 20 is thus arranged at the longitudinal end 11 of the tube 10. The dedicated part 21 is fitted into or mated with the longitudinal end 11 in such a way that a projecting portion of the articulation member 28, particularly comprising the holes 25 and 27, is situated outside the tube 10, as shown by FIG. 3. Thus, the end piece 20 is partially held in the longitudinal end 11.

A method according to the invention next involves a step in which the longitudinal end 11 is welded to the dedicated part 21, so as to secure the end piece 20 to the tube 10. In a link rod according to the invention, the tube and the dedicated part each comprise a thermoplastic. On the one hand, the tube 10 is made entirely of thermoplastic, because it is a length of section piece obtained by extruding a composite involving a fibre-filled thermoplastic matrix. In this particular instance, the thermoplastic is made of polyether ether ketone (PEEK). The thermoplastic matrix could also be selected from the group consisting of polyether ether ketone (PEEK), polyether ketone ketone (PEKK), poly(phenylene sulphide) (PPS), polyether imide (PEI). The fibres may be made up of carbon, glass and/or aramid fibres.

On the other hand, the composite of which the end piece 20 is formed is produced for example using the same thermoplastic and the same or different fibres. The entire end piece 20 here is made of such a composite with a thermoplastic matrix, namely the plates 22 and 23 and the lugs 24 and 26. Any rings that may be inserted in the holes 25 and 27 may, however, be made of metal.

In a method according to the invention, the longitudinal end 11 and the dedicated part 21 are welded together by plastic welding implementing a known technique such as ultrasonic welding, high-frequency welding, welding using heated elements (heated blade or hot plate), friction welding, pivot welding, inertia friction welding or alternatively laser welding.

Having welded the longitudinal end 11 and the dedicated part 21 together, the end piece 20 is secured to the tube 10 by means of two plastic welds. In this particular instance, the plastic welds are performed respectively between each flat surface 12 or 13, on the one hand, and each external flat surface of the plates 22 and 23, on the other.

FIGS. 4, 5 and 6 illustrate a link rod 201 according to a second embodiment of the invention. The description of the link rod 1 given hereinabove in conjunction with FIGS. 1, 2 and 3 can be read across to the link rod 201, with the exception of the differences listed below. In FIGS. 4, 5 and 6 a physical or geometric entity which is identical to or corresponds to an entity of the link rod 1 bears the same numerical reference increased by 200.

There is thus a tube 210, a longitudinal end 211, flat surfaces 212 and 213, and end piece 220, a dedicated part 221, plates 222 and 223 and an articulation member 228.

The link rod 201 differs from the link rod 1, because the end piece 20 has a rectangular cross section the perimeter of which decreases away from the longitudinal end 211. In other words, the fixing member 228 has a base 229 in the overall shape of a triangular prism. In addition, the articulation member 228 has just one lug 224 extending from the base 229 and projecting from the tube 210. The articulation member 228 has just one hole 225, formed in the lug 224, to accept a pin or an articulation of a structural component, not depicted.

Furthermore, the dedicated part 221 has a square cross section the dimensions of which correspond, give or take the mounting clearances, to those of the square cross section of the longitudinal end 211. The dedicated part 221 therefore has two lateral plates, not depicted, which extend along the axes X-X′ and Z-Z′ in such a way as to join the plates 222 and 223 together. Depending on the force to be transmitted by the link rod 201, the end piece 220 is secured to the tube 210 using one, two, three or four flat plastic welds produced around the dedicated part 221, for example between the flat surfaces 212 and 213 and a corresponding flat surface of the plates 222 and 223.

The articulation member 228 has the advantage of being light in weight and very compact. In addition, the moments of inertia of the end piece 220 are similar to the moments of inertia of the longitudinal end 211 and vary progressively from the base 229 up to the fixing member 228, and this gives the link rod 201 good mechanical strength with no discontinuity in the transmission of force.

FIGS. 7, 8 and 9 illustrate a link rod 301 that has similarities with the link rod 1. The description of the link rod 1 given hereinabove can be read across to the link rod 301, with the exception of the differences listed below. In FIGS. 7, 8 and 9, a physical or geometric entity which is identical to or corresponds to an entity of the link rod 1 bears the same numerical reference increased by 300.

There is therefore a tube 310, a longitudinal end 311, flat surfaces 312 and 313, an end piece 320, a dedicated part 321, plates 322 and 323, a lug 324, a hole 325 and an articulation member 328.

The link rod 301 differs from the link rod 201, because the tube 310 is formed of a length of section piece that has a cross section in the shape of a double H or a two-rung ladder. In other words, the tube 310 is made up of two mutually parallel flanges 302 and 303 between which two flat and mutually parallel webs 304 and 305 extend.

Furthermore, the longitudinal end 330 which is at the opposite end to the longitudinal end 320 has an articulation member 338 similar to the articulation member 28 and machined directly into the webs 304 and 305 of the tube 310.

The link rod 301 is relatively light in weight with relatively high moments of inertia. In addition, various items can be suspended from or attached to the tube 310, because of the shape of its cross section.

FIG. 10 shows a link rod 401 which is a variant of the link rod 1. The description of the link rod 1 given hereinabove in conjunction with FIGS. 1 to 3 can be read across to the link rod 401, except for the differences listed below. In FIG. 10, a physical or geometric entity which is identical to or corresponds to an entity of the link rod 1 bears the same numerical reference increased by 400.

There is therefore a tube 410, a longitudinal end 411, flat surfaces 412 and 413, and end piece 420, a dedicated part 421, plates 422 and 423, holes 425 and 427 and an articulation member 428.

The link rod 401 differs from the link rod 1 because the plates 422 and 423 consist of a superposition of thin elementary plates assembled, for example, using plastic welds on their faces. Thus, the thickness E₄₂₃ of the plate 423, measured along the axis Y-Y′ transverse to the axis X-X′, is greater than the thickness E₄₂₆ of the lug 426. Likewise, the thickness of the plate 422 is greater than the thickness of the lug 424. On the whole, the thickness of the dedicated part 421 is greater than the thickness of the articulation member 428.

The link rod 401 has high mechanical strength and moments of inertia that are locally suited to stress distribution. The link rod 401 is also lighter in weight, particularly in relation to the link rod 1, because its dedicated part does not require plates of the 22 and 23 type.

FIG. 11 illustrates a link rod 501 according to a fifth embodiment of the invention. The description of the link rod 401 given hereinabove can be read across the link rod 501, except for the differences listed below. In FIG. 11, a physical or geometric entity which is identical to or corresponds to an entity of the link rod 401 bears the same numerical reference increased by 100.

There is therefore a tube 510, a longitudinal end 511, flat surfaces 512 and 513, and end piece 520, a dedicated part 521, plates 522 and 523, holes 525 and 527, and an articulation member 528.

The link rod 501 differs from the link rod 1 or 401 because the end piece 520 has two cranked portions 520.1 and 520.2 which respectively couple the plate 522 to the lug 524 and the plate 523 to the lug 526. The cranked portions 520.1 and 520.2 here converge in the direction X-X′, that is to say from the tube 510 towards the end piece 520. Thus, the total thickness of the dedicated part 521 is greater than the total thickness of the articulation member 528, the thickness being measured along the axis Y-Y′ which is transverse to the axis X-X′. Alternatively, the cranked portions could diverge from the tube towards the end piece.

The link rod 501 is light in weight, compact and has a mechanical strength suited to tubes of small section.

FIGS. 12 and 13 illustrate a link rod 601 according to a sixth embodiment of the invention. The description of the link rod 1 given hereinabove can be read across to the link rod 601, with the exception of the differences listed below. In FIGS. 12 and 13, a physical or geometric entity which is identical to or corresponds to an entity of the link rod 1 bears the same numerical reference increased by 600.

There is therefore a tube 610, a longitudinal end 611, flat surfaces 612 and 613, an end piece 620, a dedicated part 621, plates 622 and 623, holes 625 and 627 and an articulation member 628.

The link rod 601 differs from the link rod 1 because the end piece 620 is formed by two lengths of beam with one-piece C-shaped or U-shaped cross section. The first length comprises an upper plate 622.1 and a lower plate 622.2 which are mutually parallel and joined together by a web 624. The second length comprises an upper plate 623.1 and a lower plate 623.2 which are mutually parallel and joined together by a web 626.

The first and second lengths are placed “back-to-back”, that is to say with their webs 624 and 626 parallel and relatively close together and with their respective plates 622.1, 622.2, 623.1 and 623.2 parallel in pairs and relatively distant from one another.

The external surfaces of the upper plates 622.1 and 623.1 are coplanar. Likewise, the external surfaces of the lower plates 622.2 and 623.2 are coplanar. The dedicated part 621 is formed by the plates 622.1, 622.2, 623.1 and 623.2. The longitudinal end 611 of the tube 610 has a rectangular cross section the dimensions of which complement the dimensions of the end piece 620.

The webs 624 and 626 have, in their central regions, respective holes 625 and 627 so as to form the articulation member 628. The link rod 601 also differs from the link rod 1 because the longitudinal end 611 has two holes 615 and 617 pierced coaxially in the flanks of the longitudinal end 611. As FIG. 13 shows, when the end piece 620 has been mated against the longitudinal end 611, the holes 615, 625, 627 and 617 are aligned, so as to accept a cylindrical pin or an articulation of a structural component, not depicted.

Furthermore, the longitudinal end 611 has flat surfaces 612.1, 613.1, 612.2 and 613.2 which respectively complement the plates 622.1, 623.1, 622.2 and 623.2. To make it easier to engage and fit the end piece 620 in the longitudinal end 611, the longitudinal end 611 has two cutouts 618.1 and 618.2 which extend on the axis X-X′ and which open onto the free end of the longitudinal end 611.

Once the end piece 620 has been fitted into the longitudinal end 611, the plates 622.1, 623.1, 622.2 and 623.2 respectively collaborate with the flat surfaces 612.1, 613.1, 612.2 and 613.2. The link rod 601 has four plastic welds which are formed between the following respective plates and flat surfaces:
612.1 and 622.1;
613.1 and 623.1;
612.2 and 622.2; and
613.2 and 623.2.

FIGS. 14, 15 and 16 show variants of a link rod 701 according to the invention and similar to the link rods described hereinabove in conjunction with FIGS. 1 to 13.

The main difference between the link rods 1, 201, 301, 401, 501, 601 and the link rods illustrated in FIGS. 14, 15 and 16 lies in the fact that the articulation member is no longer made from a composite material using a thermoplastic matrix, because here it consists of an end fitting 728 made of metal. Such an end fitting is, for example, described in application FR-A-2 895 041.

The end fitting 728 is attached to a dedicated part 721 of an end piece 720. For that, the end fitting 728 and the termination of the dedicated part 721 can be bonded, screwed or assembled by some equivalent means.

As in the case of the link rods illustrated in FIGS. 1 to 13, the end piece 720 is secured to a tube 710 by means of plastic welds performed between the dedicated part 721 and one longitudinal end 711 of the tube 720.

In the variant of FIG. 14, the dedicated part 721 has a narrowing of its cross section similar to that of the link rod 501.

In the variant of FIG. 15, the dedicated part 721 has the form of a cuff the cross section of which corresponds to the cross section of the longitudinal end 711.

In the variant of FIG. 16, the dedicated part 721 has the form of a box section or of a hollow housing the cross section of which corresponds to the cross section of the longitudinal end 711.

In other variants which have not been depicted, the section piece that forms the tube part of the link rod may have a cross section in the shape of a U, a J, an I or an H.

The materials selected for the matrices of the longitudinal end of the tube and of the end piece may be identical or different according to the intended application and the force to be borne by a link rod according to the invention. The plastic welds will then be of the homogeneous type, for example PEEK to PEEK as in the case of the link rod 1, or the heterogeneous type, for example PEEK to PEKK.

Moreover, the plastic welds described hereinabove in respect of the link rods of FIGS. 1 to 16 are flat welds which therefore have a relatively extensive surface area. However, depending on the forces that a link rod according to the invention has to bear, the longitudinal end of the tube and the end piece may be welded together by one or more plastic spot weld(s) and/or one or more run(s) or bead(s) of plastic welding.

A link rod according to the invention has a lightweight simplified construction because it does not require any fixing components such as rivets or bolts. In addition, a link rod according to the invention offers good mechanical strength because its moments of inertia are relatively high and because it has no pierced holes for accepting such a fixing component and which could impair the mechanical strength of the tube and/or of the end piece.

Furthermore, a link rod according to the invention presents no risk of corrosion because it uses thermoplastic materials. Furthermore, a link rod according to the invention presents no problems of differential thermal expansion because the materials used for securing the tube and the end piece together are identical.

A method according to the invention simplifies the production of such a link rod by dispensing with some of the steps in the assembly thereof.

1. Method of manufacturing a link rod for aeronautical construction, in which method plastic welding is used to secure one longitudinal end of a tube made of thermoplastic to a dedicated part, made of thermoplastic, of an end piece designed to be joined in an articulated manner to a structural component, wherein the tube is manufactured by extruding thermoplastic in order to obtain a hollow section piece one length of which constitutes the tube and which, at the longitudinal end of the tube, has at least one flat surface parallel to the longitudinal axis of the tube,
and wherein, in order to perform the plastic welding, the said at least one flat surface of the longitudinal end of the tube is mated against a corresponding flat surface belonging to the dedicated part of the end piece, then the mated flat surfaces are welded together.

2. Method according to claim 1, wherein the shape of the cross section of the section piece one length of which constitutes the tube is selected from a group consisting of a rectangle, of a square, of a U, of a J, of an I, of an H and of a double H.

3. Method according to claim 1, wherein the end piece is manufactured from one or more thermoplastic section pieces.

4. Method according to claim 3, wherein the shape of the cross section of the section piece or pieces from which the end piece is manufactured is selected from a group consisting of a rectangle, of a square, of an H, of a double H, of a C, of a J, of an I and of a U.

5. Method according to claim 1, wherein the cross section of the end piece has a perimeter which decreases away from the longitudinal end of the tube.

6. Method according to claim 1, wherein, in order to carry out the plastic welding, the end piece is partially housed in the longitudinal end of the tube

7. Method according to claim 1, wherein the tube and/or the dedicated part of the end piece are made of a composite material involving a fibre-filled thermoplastic matrix.

8. Method according to claim 7, wherein the said thermoplastic is selected from the group consisting of polyether ether ketone (PEEK), polyether ketone ketone (PEKK), poly(phenylene sulphide) (PPS), polyether imide (PEI).

9. Link rod for aeronautical construction, comprising:
a tube consisting of a length of hollow section piece which is obtained by extruding thermoplastic and which, at one longitudinal end, has at least one flat surface parallel to the longitudinal axis of the tube, and
an end piece which includes a dedicated part, made of thermoplastic, to which there is secured an articulation member designed to join the link rod to a structural component and which is secured to the tube by at least one plastic weld between the said at least one flat surface of the longitudinal end of the tube and a mating flat surface belonging to this dedicated part.

10. Link rod according to claim 9, wherein the articulation member is made of a composite with a thermoplastic matrix.

11. Link rod according to claim 9, wherein the articulation member consists of an end fitting made of metal.
